(19) United States
(12) Patent Application Publication
(10) Pub. No.: US 2026/0197445 A1
(43) Pub. Date: Jul. 9, 2026

(54) ENCODING DEVICE, DECODING DEVICE, AND NON-TRANSITORY MACHINE-READABLE MEDIUM FOR ENCODING/DECODING VIDEO DATA

(71) Applicant: SHARP KABUSHIKI KAISHA, Sakai City (JP)

(72) Inventors: YI-HAO LIN, New Taipei City (TW); YU-CHIAO YANG, New Taipei City (TW)

(21) Appl. No.: 19/440,485

(22) Filed: Jan. 5, 2026

Related U.S. Application Data
(60) Provisional application No. 63/742,235, filed on Jan. 6, 2025.

(51) Int. Cl. H04N 19/11; H04N 19/176; H04N 19/186

(52) U.S. Cl. CPC H04N 19/11; H04N 19/176; H04N 19/186

(57) ABSTRACT

An electronic device for decoding/encoding video data is provided. The electronic device receives the video data and determines a block unit from an image frame retrieved from the video data. The electronic device determines multiple first block prediction candidates based on multiple first intra prediction modes including non-angular intra prediction mode(s) and a neural network-based intra prediction mode, determines second block prediction candidate(s) based on second intra prediction mode(s) including angular intra prediction mode(s), and selects first block prediction candidate(s) based on multiple template costs of the multiple first block prediction candidates. The electronic device determines a block prediction for the block unit by weighted blending the selected first block prediction candidate(s) and the selected second block prediction candidate(s), and reconstructs the block unit based on the block prediction. In addition, a non-transitory machine-readable medium for decoding/encoding video data is also provided.

### CROSS-REFERENCE TO RELATED APPLICATION(S)

The present disclosure claims the benefit of and priority to U.S. Provisional Patent Application Ser. No. 63/742,235, filed on Jan. 6, 2025, entitled “INTRA PREDICTION FUSION WITH NEURAL NETWORK BASED INTRA PREDICTION,” the content of which is hereby incorporated herein fully by reference in its entirety into the present disclosure for all purposes.

### FIELD

The present disclosure is generally related to video coding and, more specifically, to techniques for intra prediction fusion with neural network-based intra prediction to enhance block unit reconstruction in video encoding and/or decoding.

### BACKGROUND

Video coding standards, such as H.264/AVC, HEVC, and VVC, have evolved to meet the increasing demand for efficient digital media storage and transmission. Such standards utilize intra prediction to reduce spatial redundancy by predicting the current block from reconstructed neighboring samples. Traditional intra prediction primarily relies on a set of predefined modes, including Planar, DC, and various directional modes, which are designed to model specific linear structures in the image content. To minimize signaling overhead, coding frameworks often employ mechanisms like the Most Probable Mode (MPM) list, which predicts the current mode based on the modes of adjacent blocks.

The industry moves towards next-generation standards, driving a continuous pursuit of higher coding efficiency. Such demands have led to the exploration of advanced, non-conventional prediction methods, including matrix-based intra prediction or data-driven approaches like neural network-based prediction. Emerging tools aim to capture complex, non-linear texture patterns that traditional angular modes may fail to represent accurately.

However, optimizing the use of advanced prediction models within the existing coding ecosystem presents significant challenges. Existing frameworks for mode derivation and candidate list construction are predominantly designed for conventional intra modes. Consequently, operating such advanced, non-conventional prediction models in isolation from traditional candidates limits potential coding gains and hinders the overall performance of video coding systems.

### SUMMARY

The present disclosure is directed to a device and method for intra prediction fusion with neural network-based intra prediction to enhance block unit reconstruction in video decoding.

According to a first aspect of the present disclosure, an electronic device for decoding video data is provided. The electronic device includes at least one processor and at least one non-transitory computer-readable medium coupled to the at least one processor and storing one or more computer-executable instructions. When executed by the at least one processor, the instructions cause the electronic device to: receive the video data; determine a block unit from an image frame retrieved from the video data; determine multiple first block prediction candidates based on multiple first intra prediction modes, the multiple first intra prediction modes including at least one non-angular intra prediction mode and a neural network-based intra prediction mode; determine at least one second block prediction candidate based on at least one second intra prediction mode, the at least one second intra prediction mode including at least one angular intra prediction mode; select at least one first block prediction candidate from the multiple first block prediction candidates based on multiple template costs of the multiple first block prediction candidates; determine a block prediction for the block unit by weighted blending the at least one first block prediction candidate and the at least one second block prediction candidate; and reconstruct the block unit based on the block prediction.

In some implementations of the first aspect, the at least one non-angular intra prediction mode includes at least one of a direct current (DC) mode, a planar mode, a block vector-based mode, a position-dependent intra prediction (PDP) mode, or a matrix-based intra prediction (MIP) mode.

In some implementations of the first aspect, selecting the at least one first block prediction candidate from the multiple first block prediction candidates includes: calculating the multiple template costs for the multiple block prediction candidates based on at least one of a sum of absolute difference (SAD), a weighted SAD, a sum of absolute transformed difference (SATD), a mean-removed sum of absolute difference (MR-SAD), a mean absolute difference (MAD), a mean square difference (MSD), or a structural similarity index (SSIM).

In some implementations of the first aspect, determining the at least one second block prediction candidate includes: performing a template-based intra prediction derivation (TIMD) process to determine the at least one second intra prediction mode, where the at least one second intra prediction mode includes two angular intra prediction modes.

In some implementations of the first aspect, selecting the at least one first block prediction candidate includes: determining a first template cost and a second template cost for the two angular intra prediction modes, the first template cost being less than or equal to the second template cost; determining whether a third template cost of one of the multiple first block prediction candidates, that is determined based on the neural network-based intra prediction mode, is less than 1.5 times the first template cost; and in a case that the third template cost is less than 1.5 times the first template cost, selecting the one of the multiple first block prediction candidates, which is determined based on the neural network-based intra prediction mode, as the at least one first block prediction candidate.

In some implementations of the first aspect, the block unit includes a luma block.

In some implementations of the first aspect, the block unit includes a chroma block.

According to a second aspect of the present disclosure, an electronic device for encoding video data is provided. The electronic device includes at least one processor and at least one non-transitory computer-readable medium coupled to the at least one processor and storing one or more computer-executable instructions. When executed by the at least one processor, the instructions cause the electronic device to: receive the video data; determine a block unit from an image frame retrieved from the video data; determine multiple first block prediction candidates based on multiple first intra prediction modes, the multiple first intra prediction modes including at least one non-angular intra prediction mode and a neural network-based intra prediction mode; determine at least one second block prediction candidate based on at least one second intra prediction mode, the at least one second intra prediction mode including at least one angular intra prediction mode; select at least one first block prediction candidate from the multiple first block prediction candidates based on multiple template costs of the multiple first block prediction candidates; determine a block prediction for the block unit by weighted blending the at least one first block prediction candidate and the at least one second block prediction candidate; and reconstruct the block unit based on the block prediction.

In some implementations of the second aspect, the at least one non-angular intra prediction mode includes at least one of a DC mode, a planar mode, a block vector-based mode, a PDP mode, or a MIP mode.

In some implementations of the second aspect, selecting the at least one first block prediction candidate from the multiple first block prediction candidates includes: calculating the multiple template costs for the multiple block prediction candidates based on at least one of a SAD, a weighted SAD, a SATD, a MR-SAD, a MAD, an MSD, or a SSIM.

In some implementations of the second aspect, determining the at least one second block prediction candidate includes: performing a TIMD process to determine the at least one second intra prediction mode, where the at least one second intra prediction mode includes two angular intra prediction modes.

In some implementations, selecting the at least one first block prediction candidate includes: determining a first template cost and a second template cost for the two angular intra prediction modes, the first template cost being less than or equal to the second template cost; determining whether a third template cost of one of the multiple first block prediction candidates, that is determined based on the neural network-based intra prediction mode, is less than 1.5 times the first template cost; and in a case that the third template cost is less than 1.5 times the first template cost, selecting the one of the multiple first block prediction candidates as the at least one first block prediction candidate.

In some implementations of the second aspect, the block unit includes a luma block.

In some implementations of the second aspect, the block unit includes a chroma block.

According to a third aspect of the present disclosure, a non-transitory machine-readable medium of an electronic device storing one or more computer-executable instructions for decoding video data is provided. The one or more computer-executable instructions, when executed by at least one processor of the electronic device, cause the electronic device to: receive the video data; determine a block unit from an image frame retrieved from the video data; determine multiple first block prediction candidates based on multiple first intra prediction modes, the multiple first intra prediction modes including at least one non-angular intra prediction mode and a neural network-based intra prediction mode; determine at least one second block prediction candidate based on at least one second intra prediction mode, the at least one second intra prediction mode including at least one angular intra prediction mode; select at least one first block prediction candidate from the multiple first block prediction candidates based on multiple template costs of the multiple first block prediction candidates; determine a block prediction for the block unit by weighted blending the at least one first block prediction candidate and the at least one second block prediction candidate; and reconstruct the block unit based on the block prediction.

In some implementations of the third aspect, the at least one non-angular intra prediction mode includes at least one of a DC mode, a planar mode, a block vector-based mode, a PDP mode, or a MIP mode.

In some implementations of the third aspect, selecting the at least one first block prediction candidate from the multiple first block prediction candidates includes: calculating the multiple template costs for the multiple block prediction candidates based on at least one of a SAD, a weighted SAD, a SATD, a MR-SAD, a MAD, an MSD, or a SSIM.

In some implementations of the third aspect, determining the at least one second block prediction candidate includes: performing a TIMD process to determine the at least one second intra prediction mode, where the at least one second intra prediction mode includes two angular intra prediction modes.

In some implementations of the third aspect, selecting the at least one first block prediction candidate includes: determining a first template cost and a second template cost for the two angular intra prediction modes, the first template cost being less than or equal to the second template cost; determining whether a third template cost of one of the multiple first block prediction candidates, that is determined based on the neural network-based intra prediction mode, is less than 1.5 times the first template cost; and in a case that the third template cost is less than 1.5 times the first template cost, selecting the one of the multiple first block prediction candidates as the at least one first block prediction candidate.

In some implementations of the third aspect, in the second aspect, the block unit includes a luma block or a chroma block.

### BRIEF DESCRIPTION OF THE DRAWINGS

Aspects of the present disclosure are best understood from the following detailed disclosure and the corresponding figures. Various features are not drawn to scale and dimensions of various features may be arbitrarily increased or reduced for clarity of discussion.

FIG. 1 is a block diagram illustrating a system having a first electronic device and a second electronic device for encoding and decoding video data, in accordance with one or more example implementations of the present disclosure.

FIG. 2 is a block diagram illustrating a decoder module of the second electronic device illustrated in FIG. 1, in accordance with one or more example implementations of the present disclosure.

FIG. 3 is a flowchart illustrating a method/process for decoding and/or encoding video data by an electronic device, in accordance with one or more example implementations of the present disclosure.

FIG. 4 is a diagram illustrating a pipeline of a neural network-based intra prediction mode, in accordance with one or more example implementations of the present disclosure.

FIG. 5 is a diagram illustrating a context for a block unit, in accordance with one or more example implementations of the present disclosure.

FIG. 6 is a diagram illustrating a preprocessing process, in accordance with one or more example implementations of the present disclosure.

FIG. 7 is a block diagram illustrating an encoder module of the first electronic device illustrated in FIG. 1, in accordance with one or more example implementations of the present disclosure.

### DETAILED DESCRIPTION

The following disclosure contains specific information pertaining to implementations in the present disclosure. The figures and the corresponding detailed disclosure are directed to example implementations. However, the present disclosure is not limited to these example implementations. Other variations and implementations of the present disclosure will occur to those skilled in the art.

Unless noted otherwise, like or corresponding elements among the figures may be indicated by like or corresponding reference designators. The figures and illustrations in the present disclosure are generally not to scale and are not intended to correspond to actual relative dimensions.

For the purposes of consistency and ease of understanding, features are identified (although, in some examples, not illustrated) by reference designators in the exemplary figures. However, the features in different implementations may differ in other respects and shall not be narrowly confined to what is illustrated in the figures.

The present disclosure uses the phrases “in one implementation,” or “in some implementations,” which may refer to one or more of the same or different implementations. The term “coupled” is defined as connected, whether directly or indirectly through intervening components, and is not necessarily limited to physical connections. The term “comprising” means “including, but not necessarily limited to” and specifically indicates open-ended inclusion or membership in the so-described combination, group, series, and the equivalent.

For purposes of explanation and non-limitation, specific details, such as functional entities, techniques, protocols, and standards, are set forth for providing an understanding of the disclosed technology. Detailed disclosure of well-known methods, technologies, systems, and architectures are omitted so as not to obscure the present disclosure with unnecessary details.

Persons skilled in the art will recognize that any disclosed coding function(s) or algorithm(s) described in the present disclosure may be implemented by hardware, software, or a combination of software and hardware. Disclosed functions may correspond to modules that are software, hardware, firmware, or any combination thereof.

A software implementation may include a program having one or more computer-executable instructions stored on a computer-readable medium, such as memory or other types of storage devices. For example, one or more microprocessors or general-purpose computers with communication processing capability may be programmed with computer-executable instructions and perform the disclosed function(s) or algorithm(s).

The microprocessors or general-purpose computers may be formed of application-specific integrated circuits (ASICs), programmable logic arrays, and/or one or more digital signal processors (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes, but is not limited to, random-access memory (RAM), read-only memory (ROM), erasable programmable read-only memory (EPROM), electrically erasable programmable read-only memory (EEPROM), flash memory, compact disc read-only memory (CD ROM), magnetic cassettes, magnetic tape, magnetic disk storage, or any other equivalent medium capable of storing computer-executable instructions. The computer-readable medium may be a non-transitory computer-readable medium.

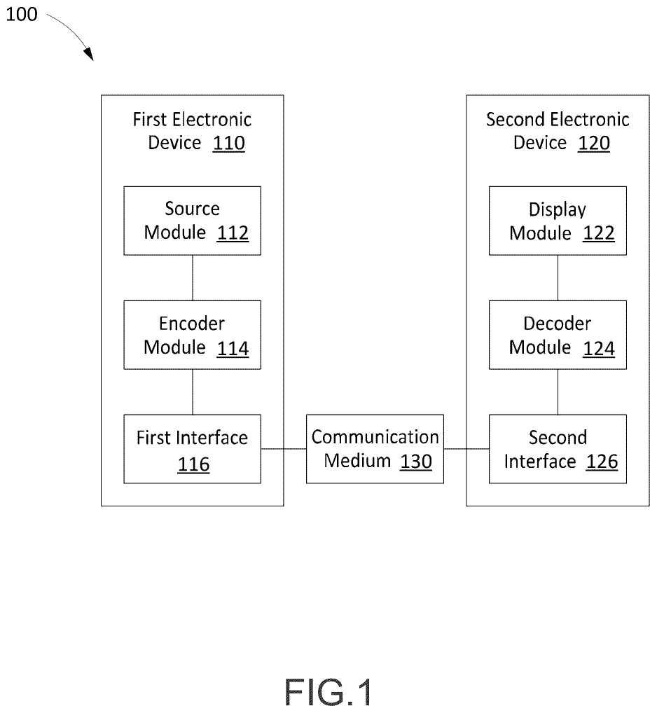

FIG. 1 is a block diagram illustrating a system 100 having a first electronic device and a second electronic device for encoding and decoding video data, in accordance with one or more example implementations of this disclosure.

The system 100 includes a first electronic device 110, a second electronic device 120, and a communication medium 130.

The first electronic device 110 may be a source device including any device configured to encode video data and transmit the encoded video data to the communication medium 130. The second electronic device 120 may be a destination device including any device configured to receive encoded video data via the communication medium 130 and decode the encoded video data.

The first electronic device 110 may communicate via wire, or wirelessly, with the second electronic device 120 via the communication medium 130. The first electronic device 110 may include a source module 112, an encoder module 114, and a first interface 116, among other components. The second electronic device 120 may include a display module 122, a decoder module 124, and a second interface 126, among other components. The first electronic device 110 may be a video encoder and the second electronic device 120 may be a video decoder.

The first electronic device 110 and/or the second electronic device 120 may be a mobile phone, a tablet, a desktop, a notebook, or other electronic devices. FIG. 1 illustrates one example of the first electronic device 110 and the second electronic device 120. The first electronic device 110 and second electronic device 120 may include greater or fewer components than illustrated or have a different configuration of the various illustrated components.

The source module 112 may include a video capture device to capture new video, a video archive to store previously captured video, and/or a video feed interface to receive the video from a video content provider. The source module 112 may generate computer graphics-based data, as the source video, or may generate a combination of live video, archived video, and computer-generated video, as the source video. The video capture device may include a charge-coupled device (CCD) image sensor, a complementary metal-oxide-semiconductor (CMOS) image sensor, or a camera.

The encoder module 114 and the decoder module 124 may each be implemented as any one of a variety of suitable encoder/decoder circuitry, such as one or more microprocessors, a central processing unit (CPU), a graphics processing unit (GPU), a system-on-a-chip (SoC), digital signal processors (DSPs), application-specific integrated circuits (ASICs), field-programmable gate arrays (FPGAs), discrete logic, software, hardware, firmware, or any combinations thereof. When implemented partially in software, a device may store the program having computer-executable instructions for the software in a suitable, non-transitory computer-readable medium and execute the stored computer-executable instructions using one or more processors to perform the disclosed methods. Each of the encoder module 114 and the decoder module 124 may be included in one or more encoders or decoders, any of which may be integrated as part of a combined encoder/decoder (CODEC) in a device.

The first interface 116 and the second interface 126 may utilize customized protocols or follow existing standards or de facto standards including, but not limited to, Ethernet, IEEE 802.11 or IEEE 802.15 series, wireless USB, or telecommunication standards including, but not limited to, Global System for Mobile Communications (GSM), Code-Division Multiple Access 2000 (CDMA2000), Time Division Synchronous Code Division Multiple Access (TD-SCDMA), Worldwide Interoperability for Microwave Access (WiMAX), Third Generation Partnership Project Long-Term Evolution (3GPP-LTE), or Time-Division LTE (TD-LTE). The first interface 116 and the second interface 126 may each include any device configured to transmit a compliant video bitstream via the communication medium 130 and to receive the compliant video bitstream via the communication medium 130.

The first interface 116 and the second interface 126 may include a computer system interface that enables a compliant video bitstream to be stored on a storage device or to be received from the storage device. For example, the first interface 116 and the second interface 126 may include a chipset supporting Peripheral Component Interconnect (PCI) and Peripheral Component Interconnect Express (PCIe) bus protocols, proprietary bus protocols, Universal Serial Bus (USB) protocols, Inter-Integrated Circuit (I2C) protocols, or any other logical and physical structure(s) that may be used to interconnect peer devices.

The display module 122 may include a display using liquid crystal display (LCD) technology, plasma display technology, organic light-emitting diode (OLED) display technology, or light-emitting polymer display (LPD) technology, with other display technologies used in some other implementations. The display module 122 may include a High-Definition display or an Ultra-High-Definition display.

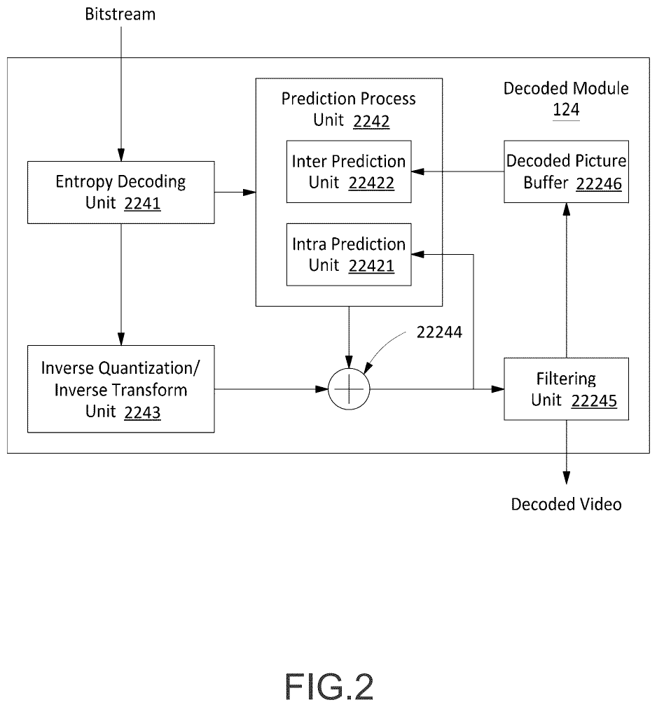

FIG. 2 is a block diagram illustrating a decoder module 124 of the second electronic device 120 illustrated in FIG. 1, in accordance with one or more example implementations of this disclosure. The decoder module 124 may include an entropy decoder (e.g., an entropy decoding unit 2241), a prediction processor (e.g., a prediction processing unit 2242), an inverse quantization/inverse transform processor (e.g., an inverse quantization/inverse transform unit 2243), a summer (e.g., a summer 2244), a filter (e.g., a filtering unit 2245), and a decoded picture buffer (e.g., a decoded picture buffer 2246). The prediction processing unit 2242 further may include an intra prediction processor (e.g., an intra prediction unit 22421) and an inter prediction processor (e.g., an inter prediction unit 22422). The decoder module 124 receives a bitstream, decodes the bitstream, and outputs a decoded video.

The entropy decoding unit 2241 may receive the bitstream including multiple syntax elements from the second interface 126, as shown in FIG. 1, and perform a parsing operation on the bitstream to extract syntax elements from the bitstream. As part of the parsing operation, the entropy decoding unit 2241 may entropy decode the bitstream to generate quantized transform coefficients, quantization parameters, transform data, motion vectors, intra modes, partition information, and/or other syntax information.

The entropy decoding unit 2241 may perform context-adaptive variable length coding (CAVLC), context-adaptive binary arithmetic coding (CABAC), syntax-based context-adaptive binary arithmetic coding (SBAC), probability interval partitioning entropy (PIPE) coding, or another entropy coding technique to generate the quantized transform coefficients. The entropy decoding unit 2241 may provide the quantized transform coefficients, the quantization parameters, and the transform data to the inverse quantization/inverse transform unit 2243 and provide the motion vectors, the intra modes, the partition information, and other syntax information to the prediction processing unit 2242.

The prediction processing unit 2242 may receive syntax elements, such as motion vectors, intra modes, partition information, and other syntax information, from the entropy decoding unit 2241. The prediction processing unit 2242 may receive the syntax elements including the partition information and divide image frames according to the partition information.

Each of the image frames may be divided into at least one image block according to the partition information. The at least one image block may include a luminance block for reconstructing multiple luminance samples and at least one chrominance block for reconstructing multiple chrominance samples. The luminance block and the at least one chrominance block may be further divided to generate macroblocks, coding tree units (CTUs), coding blocks (CBs), sub-divisions thereof, and/or other equivalent coding units.

During the decoding process, the prediction processing unit 2242 may receive predicted data including the intra mode or the motion vector for a current image block of a specific one of the image frames. The current image block may be the luminance block or one of the chrominance blocks in the specific image frame.

The intra prediction unit 22421 may perform intra-predictive coding of a current block unit relative to one or more neighboring blocks in the same frame as the current block unit based on syntax elements related to the intra mode in order to generate a predicted block. The intra mode may specify the location of reference samples selected from the neighboring blocks within the current frame. The intra prediction unit 22421 may reconstruct multiple chroma components of the current block unit based on multiple luma components of the current block unit when the multiple chroma components is reconstructed by the prediction processing unit 2242.

The intra prediction unit 22421 may reconstruct multiple chroma components of the current block unit based on the multiple luma components of the current block unit when the multiple luma components of the current block unit are reconstructed by the prediction processing unit 2242.

The inter prediction unit 22422 may perform inter-predictive coding of the current block unit relative to one or more blocks in one or more reference image blocks based on syntax elements related to the motion vector in order to generate the predicted block.

The motion vector may indicate a displacement of the current block unit within the current image block relative to a reference block unit within the reference image block. The reference block unit may be a block (e.g., in a reference frame) determined to closely match the current block unit.

The inter prediction unit 22422 may receive the reference image block stored in the decoded picture buffer 2246 and reconstruct the current block unit based on the received reference image blocks.

The inverse quantization/inverse transform unit 2243 may apply inverse quantization and inverse transformation to reconstruct the residual block in the pixel domain. The inverse quantization/inverse transform unit 2243 may apply inverse quantization to the residual quantized transform coefficient to generate a residual transform coefficient and then apply inverse transformation to the residual transform coefficient to generate the residual block in the pixel domain.

The inverse transformation may be inversely applied by the transformation process, such as a discrete cosine transform (DCT), a discrete sine transform (DST), an adaptive multiple transform (AMT), a mode-dependent non-separable secondary transform (MDNSST), a Hypercube-Givens transform (HyGT), a signal-dependent transform, a Karhunen-Loéve transform (KLT), a wavelet transform, an integer transform, a sub-band transform, or a conceptually similar transform. The inverse transformation may convert the residual information from a transform domain, such as a frequency domain, back to the pixel domain, etc. The degree of inverse quantization may be modified by adjusting a quantization parameter.

The summer 2244 may add the reconstructed residual block (e.g., residual samples of the block) to the predicted block (e.g., predicted samples of the block) provided by the prediction processing unit 2242 to produce a reconstructed block.

The filtering unit 2245 may include a deblocking filter, a sample adaptive offset (SAO) filter, a bilateral filter, and/or an adaptive loop filter (ALF) to remove the blocking artifacts from the reconstructed block. Additional filters (in loop or post loop) may also be used in addition to the deblocking filter, the SAO filter, the bilateral filter, and the ALF. Such filters (which are not explicitly illustrated for the brevity of description) may filter the output of the summer 2244. The filtering unit 2245 may output the decoded video to the display module 122 or other video receiving units after the filtering unit 2245 performs the filtering process for the reconstructed blocks of the specific image frame.

The decoded picture buffer 2246 may be a reference picture memory that stores the reference block to be used by the prediction processing unit 2242 in decoding the bitstream (e.g., in inter-coding modes). The decoded picture buffer 2246 may be formed by any one of a variety of memory devices, such as a dynamic random-access memory (DRAM), including synchronous DRAM (SDRAM), magneto-resistive RAM (MRAM), resistive RAM (RRAM), or other types of memory devices. The decoded picture buffer 2246 may be on-chip along with other components of the decoder module 124 or may be off-chip relative to those components.

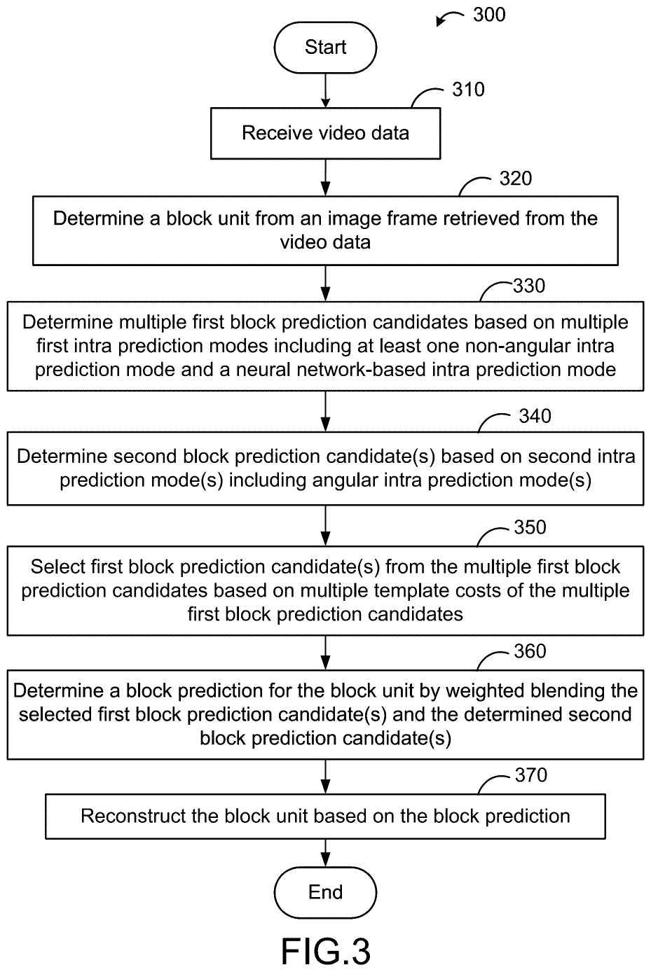

FIG. 3 is a flowchart illustrating a method/process 300 for decoding and/or encoding video data by an electronic device, in accordance with one or more example implementations of this disclosure. The method/process 300 is an example implementation, as there may be a variety of methods of decoding/encoding the video data.

The method/process 300 may be performed by an electronic device, such as the electronic device 110 or electronic device 120, using the configurations illustrated in FIGS. 1 and 2, where various elements of these figures may be referenced to describe the method/process 300. Each action illustrated in FIG. 3 may represent one or more processes, methods, or subroutines performed by an electronic device.

The order in which the actions appear in FIG. 3 is for illustration only and may not be construed to limit the scope of the present disclosure, thus may be different from what is illustrated. Additional actions may be added, or less actions may be utilized without departing from the scope of the present disclosure.

In action 310, the method/process 300 may start by receiving (e.g., by the decoder module 124/encoder module 114) the video data.

With reference to FIG. 1 and FIG. 2, the second electronic device 120 may receive the bitstream from an encoder, such as the first electronic device 110, or from other video providers, via the second interface 126. The second interface 126 may provide the bitstream to the decoder module 124.

For example, from the decoder's perspective, the video data received by the decoder module 124 may include a bitstream provided by the encoder module 114, which may include information of multiple image frames. From the encoder's perspective though, the video data received by the encoder module 114 may include one or more uncompressed image frames, which may represent the input video signal to be compressed.

The entropy decoding unit 2241 may decode the bitstream to determine multiple prediction indications and multiple partitioning indications for multiple video images. The decoder module 124 may then reconstruct the video images based on the prediction indications and the partitioning indications. The prediction indications and the partitioning indications may include multiple flags and multiple indices.

In action 320, the method/process 300 may determine (e.g., by the decoder module 124/encoder module 114), a block unit from an image frame retrieved from the video data.

With reference to FIG. 1 and FIG. 2, the decoder module 124 may determine or retrieve the image frames from the bitstream and may divide each image frame to determine the block units, according to the partition indications in the bitstream. For example, the decoder module 124 may divide the image frames to generate multiple CTUs and further divide one of the CTUs to determine the block units, according to the partition indications, using any video coding standard.

From the decoder's perspective, the video data may include the bitstream from the encoder, and a block unit may be determined from an image frame, according to the partitioning information (e.g., QT/MTT/SBT split flags) parsed from the bitstream. From the encoder's perspective, the video data may include one or more uncompressed image frames, and the block unit may be determined based on rate-distortion optimized partitioning decisions by evaluating possible QT, MTT, or other split structures that are applied to the current CTU or CU being processed.

In some implementations, the block unit may be a current block. The current block may include at least one of a coding unit, a prediction unit, a macroblock, a luma block, and a chroma block. As an example, the current block may be a luma block. As another example, the current block may be a chroma block.

In action 330, the method/process 300 may determine (e.g., by the decoder module 124/encoder module 114) multiple first block prediction candidates based on multiple first intra prediction modes. The first intra prediction modes may include at least one non-angular intra prediction mode and a neural network (NN)-based intra prediction mode. The decoder module 124/encoder module 114 may apply at least one non-angular intra prediction mode on the block unit to obtain at least one first block prediction candidate, and may additionally apply the NN-based intra prediction mode on the block unit to obtain another first block prediction candidate.

In some implementations, the at least one non-angular intra prediction mode may include at least one of a direct current (DC) mode, a planar mode, a block vector-based mode (e.g., intra template matching, intra block copy, etc.), a position-dependent intra prediction (PDP) mode, or a matrix-based intra prediction (MIP) mode.

It should be noted that, in the present disclosure, the NN-based intra prediction mode may not only be classified as either the angular intra prediction mode or the non-angular intra prediction mode, since an equivalent intra mode of the NN-based intra prediction mode may not be limited to a specific category. In other words, the equivalent intra mode of the NN-based intra prediction mode may correspond to an angular intra prediction mode or a non-angular intra prediction mode. On the other hand, the NN-based intra prediction mode may be considered to be one of the non-angular intra prediction modes. In some implementations of the present disclosure, the NN-based intra prediction mode may be utilized to generate a block prediction that is used to replace a non-angular intra prediction in a subsequent fusion process. Therefore, the non-angular intra prediction modes may be considered to include the NN-based intra prediction mode in such implementations.

The NN-based intra prediction mode may be used to predict a block unit to generate an intra prediction candidate. In some implementations, the NN-based intra prediction mode may be associated with multiple neural networks, and each neural network may be used for predicting a block unit of a different size. For example, the NN-based intra prediction mode may be associated with 6 neural networks for predicting the block unit with six sizes of 4×4, 8×4, 16×4, 8×8, 8×16, and 16×16. As another example, the NN-based intra prediction mode may be associated with 7 neural networks for predicting the block unit with seven sizes of 4×4, 8×4, 16×4, 32×4, 8×8, 8×16, and 16×16.

In some implementations, when a neural network is used for predicting a (small) block, the neural network may be subsampled or downsampled from another neural network that is used for predicting a larger block than, for example, the (small) block. Therefore, the number of neural networks may be less than or equal to the number of available block sizes.

In some implementations, the decoder module 124/encoder module 114 may determine whether to enable the NN-based intra prediction mode based on a syntax element. For example, for a luma block having a size belonging to a predefined set, the decoder module 124/encoder module 114 may parse a flag (e.g., nnFlag) first. When the flag indicates the mode is enabled, the decoder module 124/encoder module 114 may proceed to generate the first block prediction candidate (e.g., also referred to as an NN-based intra prediction candidate) based on the NN-based intra prediction mode. In some implementations, if a context of the block unit goes out of bounds of a current image frame, the decoder module 124/encoder module 114 may replace the NN-based intra prediction candidate with a default prediction, such as a Planar prediction.

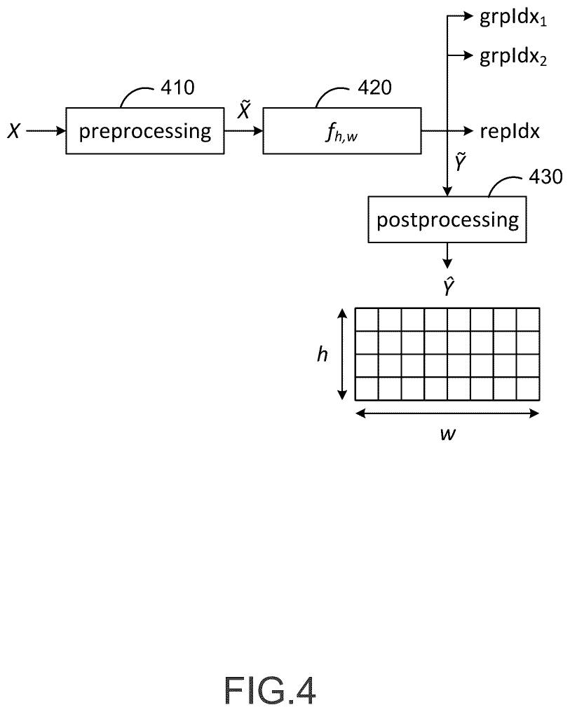

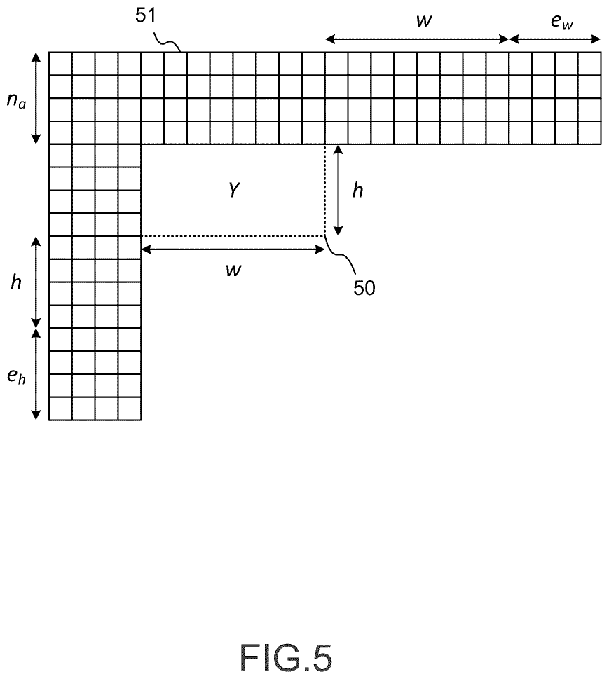

FIG. 4 is a diagram illustrating a pipeline of an NN-based intra prediction mode, in accordance with one or more example implementations of the present disclosure. Additionally, FIG. 5 is a diagram illustrating a context for the block unit, in accordance with one or more example implementations of the present disclosure.

Referring to FIGS. 4 and 5, in some implementations, the NN-based intra prediction mode may include a preprocessing step 410, an inference process 420 and a postprocessing step 430. For the block unit 50 (e.g., Y), the decoder module 124/encoder module 114 may select a specific neural network (e.g., f_{h,w}) that is corresponding to a width (e.g., w) and a height (e.g., h) of the block unit 50.

In the preprocessing step 410, the decoder module 124/encoder module 114 may determine a context 51 (e.g., X) for the block unit 50. The context 51 may include multiple reference samples associated with the block unit 50. For example, the context 51 may include nₐ rows of reference samples located above the block unit 50 and nₗ columns of reference samples located on a left side of the block unit 50. In some implementation, the context 51 may further include an extended width (e.g., e_{w}) and an extended height (e.g., eₕ), as shown in FIG. 5.

In some implementations, when a minimum of the height and the width is less than or equal to 8, and an area of the block unit 50 is less than 256, the decoder module 124/encoder module 114 may assign a value of the minimum of the height and the width to both nₐ and nₗ. In some implementations, when the height exceeds 8, the decoder module 124/encoder module 114 may assign a value of half the heigh to nₐ. In some implementations, when the width exceeds 8, the decoder module 124/encoder module 114 may assign a value of half the width to nₗ.

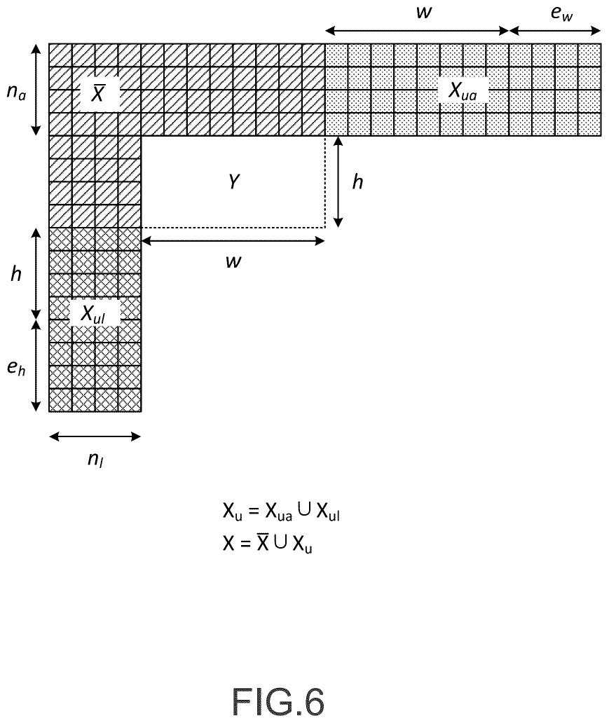

FIG. 6 is a diagram illustrating a preprocessing process, in accordance with one or more example implementations of the present disclosure.

Referring to FIGS. 4 to 6, in the preprocessing step 410, the decoder module 124/encoder module 114 may determine the context 51 (e.g., X) including a set of available reference samples (e.g., X̅) and a set of unavailable reference samples (e.g., Xᵤ). The available reference samples may include reconstructed samples adjacent to the block unit 50. The unavailable reference samples may include samples located in an extended region of the context 51 (e.g., Xᵤₐ and Xᵤₗ).

In some implementations, in the preprocessing step 410, the decoder module 124/encoder module 114 may determine a mean (e.g., μ, which is not shown in FIGS. 4 to 6) of the available reference samples (e.g., X̅) in the context 51. The decoder module 124/encoder module 114 may subtract the mean from the available reference samples.

In some implementations, after the subtraction, the decoder module 124/encoder module 114 may further scale the available reference samples. When the specific neural network is in floats, the decoder module 124/encoder module 114 may multiply the available reference samples by a factor (e.g., ρ) derived based on an internal bitdepth b (e.g., ρ=1/(2\hat{ }(b−8))). When the specific neural network is not in floats, the decoder module 124/encoder module 114 may multiply the available reference samples by the factor derived based on an input quantizer Qᵢₙ (e.g., ρ=2\hat{ }(Qᵢₙ−b+8))).

In some implementations, in the preprocessing step 410, the decoder module 124/encoder module 114 may set all the unavailable reference samples (e.g., Xᵤ=Xᵤₐ ∪Xᵤₗ) in the context 51 to zero.

In some implementations, in the preprocessing step 410, the decoder module 124/encoder module 114 may further flatten the context 51 (e.g., X=X̅∪Xᵤ) to yield a vector (e.g., \tilde{X}) as an input of the specific neural network (e.g., f_{h,w}).

Referring back to FIG. 4, in the inference process 420, the decoder module 124/encoder module 114 may apply the vector (e.g., \tilde{X}) to the specific neural network (e.g., f_{h,w}). For example, the specific neural network may include sequential matrix multiplications and one or more piecewise-linear functions (e.g., ReLU, LeakyReLU, etc.).

In some implementations, in the inference process 420, the specific neural network may generate a prediction output (e.g., \tilde{Y}) and one or more indices. The one or more indices may include at least one group index (e.g., grpIdx₁, grpIdx₂, etc.) and a representative index (e.g., repIdx). The group index may characterize a Low-Frequency Non-Separable Secondary Transform (LFNST) kernel index and a transposition state. The representative index may indicate a conventional intra prediction mode (e.g., Planar, DC, or angular mode). In some implementations, the representative index may indicate an equivalent intra mode for the block unit. For example, the equivalent intra mode may be used to construct a Most Probable Mode (MPM) list for a subsequent block unit. Specifically, even if the block unit is predicted using the NN-based intra prediction mode, the block unit may still provide a valid mode index for the subsequent block unit's mode derivation process (e.g., Template-based Intra Mode Derivation (TIMD), Decoder-side Intra Mode Derivation (DIMD), etc.).

Referring back to FIG. 4, in the postprocessing step 430, the decoder module 124/encoder module 114 may reshape the prediction output (e.g., \tilde{Y}) into a rectangle having the width and the height of the block unit 50. The decoder module 124/encoder module 114 may divide the rectangle by the factor (e.g., ρ). Then, the decoder module 124/encoder module 114 may add the mean (e.g., μ) to the rectangle. Afterwards, the decoder module 124/encoder module 114 may clip the result to a valid range to generate the NN-based intra prediction candidate (e.g., Ŷ).

For example, the postprocessing step 430 may be represented by:

$$\hat{Y} = min ( max ( \frac{reshape ( \tilde{Y} )}{ρ} + μ , 0 ) , {2}^{b} - 1 ) .$$

Based on the above descriptions, a first block prediction candidate (e.g., the NN-based intra prediction candidate) may be determined based on the NN-based intra prediction mode. It should be noted that details of the method to determine the at least one first block prediction candidate for the block unit 50 based on at least one non-angular intra prediction mode, such as the DC mode, the planar mode, the block vector-based mode, the PDP mode, or the MIP mode, are not described herein, as such implementations may be realized in accordance with available video coding standards or other suitable techniques.

Referring back to FIG. 3, in action 340, the method/process 300 may determine (e.g., by the decoder module 124/encoder module 114) at least one second block prediction candidate based on at least one second intra prediction mode. The at least one second intra prediction mode may include at least one angular intra prediction mode. In some implementations, the decoder module 124/encoder module 114 may determine at least one second intra prediction mode and the at least one second block prediction candidate based on a mode derivation process.

In some implementations, the mode derivation process may be a TIMD process. For example, the decoder module 124/encoder module 114 may determine a template cost for each of multiple intra prediction modes (e.g., angular modes 2 to 66) based on the template region(s) that is/are adjacent to the block unit. The decoder module 124/encoder module 114 may select a predetermined number of (e.g., angular) intra prediction modes that have minimum template costs, as the at least one second intra prediction mode. In some implementations, the predetermined number may be two. Accordingly, the at least one second intra prediction mode may include two (e.g., angular) intra prediction modes (e.g., associated with the lowest template costs). The decoder module 124/encoder module 114 may determine the at least one second block prediction candidate based on the two (e.g., angular) intra prediction modes.

In some implementations, the template cost may be determined based on a cost function. The cost function may be one of a sum of absolute difference (SAD), a weighted SAD, a sum of absolute transformed difference (SATD), a mean-removed sum of absolute difference (MR-SAD), a mean absolute difference (MAD), a mean square difference (MSD), or a structural similarity index (SSIM).

In some implementations, the mode derivation process may be a DIMD process. For example, the decoder module 124/encoder module 114 may determine a Histogram of Gradient (HoG) based on multiple reconstructed neighboring samples. The decoder module 124/encoder module 114 may select N intra prediction modes, as the at least one second intra prediction mode based on the HoG. Accordingly, the at least one second intra prediction mode may include N (e.g., angular) intra prediction modes, where the number N may be a positive integer, such as 5 or 6. The decoder module 124/encoder module 114 may determine N second block prediction candidates based on the N (e.g., angular) intra prediction modes.

In some implementations, the mode derivation process may be an Occurrence-Based Intra Coding (OBIC) process. For example, the decoder module 124/encoder module 114 may determine a Histogram of Occurrence (HoO) based on intra prediction modes used by multiple neighboring blocks (e.g., adjacent and/or non-adjacent blocks) of the block unit. The decoder module 124/encoder module 114 may select N intra prediction modes that have the highest occurrences in the HoO, as the at least one second intra prediction mode. The decoder module 124/encoder module 114 may determine N second block prediction candidates based on the N intra prediction modes.

In some implementations, the mode derivation process may involve Multiple Reference Lines (MRLs). For example, the decoder module 124/encoder module 114 may determine the at least one second block prediction candidate based on multiple reconstructed neighboring samples from M reference lines, where the number M may be a positive integer, such as 2 or 3. The at least one second intra prediction mode may include an intra prediction mode associated with a default reference line. The at least one second intra prediction mode may include an intra prediction mode associated with a non-adjacent reference line (e.g., a reference line having a non-zero reference index). In some implementations, the decoder module 124/encoder module 114 may determine a (e.g., first) prediction candidate of the at least one second block prediction candidate based on the intra prediction mode associated with the default reference line and the reconstructed neighboring samples of the default reference line. In some implementations, the decoder module 124/encoder module 114 may determine a (e.g., second) prediction candidate of the at least one second block prediction candidate based on the intra prediction mode associated with the non-adjacent reference line and the reconstructed neighboring samples of the non-adjacent reference line. The non-adjacent reference line may be located further from the block unit than the default reference line.

In some implementations, the mode derivation process may be a Spatial Geometric Partitioning Mode (SGPM) process. For example, the decoder module 124/encoder module 114 may determine an SGPM candidate list. The SGPM candidate list may include a predetermined number of candidates (e.g., up to 10 candidates). The SGPM candidate list may include one or more angular intra prediction modes (e.g., regular intra candidates) and one or more block vector-based candidates. The decoder module 124/encoder module 114 may determine the at least one second block prediction candidate based on the SGPM candidate list (e.g., at least one of the one or more angular intra prediction modes). In some implementations, the SGPM candidate list may also include an NN-based intra prediction candidate (e.g., that is determined in action 330).

Referring back to FIG. 3, in action 350, the method/process 300 may select (e.g., by the decoder module 124/encoder module 114) at least one first block prediction candidate from the multiple first block prediction candidates (e.g., determined in action 330) based on multiple template costs of the multiple first block prediction candidates.

In some implementations, the decoder module 124/encoder module 114 may calculate the multiple template costs for the multiple first block prediction candidates based on at least one of an SAD, a weighted SAD, an SATD, an MR-SAD, an MAD, an MSD, or an SSIM.

In some implementations, the decoder module 124/encoder module 114 may select one (or more) of the multiple first block prediction candidates that is/are associated with the lowest template cost(s). In some implementations, the selected first block prediction candidate may include the NN-based intra prediction candidate.

In some implementations, the above-mentioned selection may be performed in the TIMD process. For example, the decoder module 124/encoder module 114 may determine a first template cost and a second template cost for the at least one second block prediction candidate (e.g., the two angular intra prediction modes determined in action 340). The first template cost may be less than or equal to the second template cost. The decoder module 124/encoder module 114 may determine a third template cost of a specific block prediction candidate, where the specific block prediction candidate may have the lowest template cost among the multiple first block prediction candidates determined in action 330. The decoder module 124/encoder module 114 may determine whether the third template cost is less than a threshold derived from the first template cost.

In some implementations, the decoder module 124/encoder module 114 may determine whether the third template cost is less than 1.5 times the first template cost. In response to determining that the third template cost is less than 1.5 times the first template cost, the decoder module 124/encoder module 114 may select the specific block prediction candidate. In some implementations, in response to determining that the third template cost is not less than 1.5 times the first template cost, the decoder module 124/encoder module 114 may select a conventional non-angular intra prediction candidate (e.g., a Planar mode candidate). In some implementations, the specific block prediction candidate may be determined based on the NN-based intra prediction mode.

In some implementations, the above-mentioned selection may be performed in the DIMD process or the OBIC process. For example, the decoder module 124/encoder module 114 may select a specific block prediction candidate having the lowest template cost among the multiple first block prediction candidates determined in action 330. When the specific block prediction candidate is determined based on the NN-based intra prediction mode, the specific block prediction candidate (e.g., the NN-based intra prediction candidate) may be selected (e.g., as one of the at least one first block prediction candidate) to be fused with the at least one second block prediction candidate (e.g., the N intra prediction modes selected based on the HoG or the HoO).

In some implementations, the above-mentioned selection may be performed in the SGPM process. The decoder module 124/encoder module 114 may reorder the SGPM candidate list based on the template costs. The decoder module 124/encoder module 114 may select, based on the template costs, the at least one first block prediction candidate and the at least one second block prediction candidate from the reordered SGPM candidate list. For example, the at least one first block prediction candidate may include the NN-based intra prediction candidate.

In some implementations, the above-mentioned selection may be performed based on the MRL. The decoder module 124/encoder module 114 may select the NN-based intra prediction candidate associated with the default reference line (e.g., as one of the at least one first block prediction candidate). In some implementations, the selection of the NN-based intra prediction candidate may be contingent on a template cost comparison between the NN-based intra prediction candidate and other first block prediction candidates derived from the default reference line.

Referring back to FIG. 3, in action 360, the method/process 300 may determine (e.g., by the decoder module 124/encoder module 114) a block prediction for the block unit by weighted blending the at least one first block prediction candidate (e.g., determined in action 350) with the at least one second block prediction candidate (e.g., determined in action 340).

In some implementations, the aforementioned weighted blending may be performed in the TIMD process. The decoder module 124/encoder module 114 may determine the block prediction by weighted blending the at least one first block prediction candidate (e.g., the NN-based intra prediction candidate) with the two angular intra prediction modes. For example, the NN-based intra prediction candidate may replace a Planar mode candidate in the weighted blending in the TIMD process. The decoder module 124/encoder module 114 may determine the weights for the weighted blending based on the multiple template costs (e.g., the first template cost, the second template cost, and the third template cost, as described above) associated with each prediction candidate.

In some implementations, the weighted blending may be performed in the DIMD process. The decoder module 124/encoder module 114 may determine the block prediction by weighted blending the at least one first block prediction candidate (e.g., the NN-based intra prediction candidate) with the N intra prediction modes selected based on the HoG. The decoder module 124/encoder module 114 may derive the weights for the weighted blending based on amplitudes of the HoG associated with the N intra prediction modes.

In some implementations, the weighted blending may be performed in the OBIC process. The decoder module 124/encoder module 114 may determine the block prediction by weighted blending the at least one first block prediction candidate (e.g., the NN-based intra prediction candidate) with the N intra prediction modes selected based on the HoO. The decoder module 124/encoder module 114 may determine the weights for the weighted blending based on occurrences of the N intra prediction modes in the HoO.

In some implementations, the weighted blending may be performed based on the MRL. The decoder module 124/encoder module 114 may determine the block prediction by weighted blending the at least one first block prediction candidate (e.g., the NN-based intra prediction candidate) with the at least one second block prediction candidate determined based on multiple reconstructed neighboring samples from the M reference lines. For example, the decoder module 124/encoder module 114 may fuse the intra prediction candidate from the default reference line and the intra prediction candidate from the non-adjacent reference line, together with the NN-based intra prediction candidate associated with the default reference line. For example, the decoder module 124/encoder module 114 may fuse the intra prediction candidate from the non-adjacent reference line, together with the NN-based intra prediction candidate associated with the default reference line. As another example, the decoder module 124/encoder module 114 may fuse the intra prediction candidate from the default reference line together with the NN-based intra prediction candidate associated with the non-adjacent reference line.

In some implementations, the weighted blending may be performed in the SGPM process. The decoder module 124/encoder module 114 may determine the block prediction based on a first prediction (e.g., generated based on the at least one first block prediction candidate such as the NN-based intra prediction candidate) and a second prediction (e.g., generated based on the at least one second block prediction candidate) and a split line. The decoder module 124/encoder module 114 may determine the block prediction by weighted blending the first prediction and the second prediction, according to the weights derived from the split line. For example, the weights may be determined based on a distance between a sample position and the derived split line.

In some implementations, the split line may be determined based on two predefined matrices for combining the first prediction and the second prediction, respectively. In some implementations, the split line may be determined on-the-fly. For example, the split line may be determined based on characteristics of the reconstructed neighboring samples (e.g., gradients or edges), rather than parsing a split index from the bitstream.

In some implementations, the weighted blending may be performed in a Combined Inter and Intra Prediction (CIIP) mode. The decoder module 124/encoder module 114 may determine the block prediction by weighted blending an inter prediction signal (e.g., predicted using a CIIP-TM merge candidate) with an intra prediction signal predicted using the NN-based intra prediction candidate.

Referring back to FIG. 3, in action 370, the method/process 300 may reconstruct the block unit based on the block prediction.

In some implementations, the decoder module 124/encoder module 114 may determine the predicted samples of the block unit (e.g., P(x, y)), and then reconstruct the block unit based on the predicted samples. In some implementations, the decoder module 124/encoder module 114 may add multiple residual components to the predicted samples of the block unit to reconstruct the block unit. The residual components may be determined from the bitstream. Once the block unit is reconstructed, the method/process 300 may then end. By repeating the method/process 300, multiple block units may be reconstructed and, as a result, the image frames included in the video data may be reconstructed accordingly.

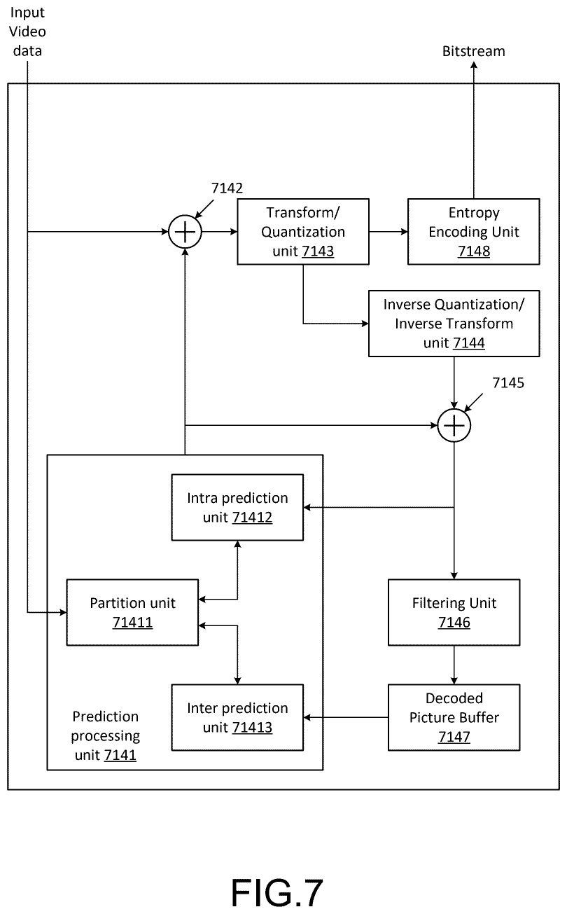

FIG. 7 is a block diagram illustrating an encoder module 114 of the first electronic device 110 illustrated in FIG. 1, in accordance with one or more example implementations of this disclosure. The encoder module 114 may include a prediction processor (e.g., a prediction processing unit 7141), at least a first summer (e.g., a first summer 7142) and a second summer (e.g., a second summer 7145), a transform/quantization processor (e.g., a transform/quantization unit 7143), an inverse quantization/inverse transform processor (e.g., an inverse quantization/inverse transform unit 7144), a filter (e.g., a filtering unit 7146), a decoded picture buffer (e.g., a decoded picture buffer 7147), and an entropy encoder (e.g., an entropy encoding unit 7148). The prediction processing unit 7141 of the encoder module 114 may further include a partition processor (e.g., a partition unit 71411), an intra prediction processor (e.g., an intra prediction unit 71412), and an inter prediction processor (e.g., an inter prediction unit 71413).

The encoder module 114 may receive the source video and encode the source video to output a bitstream. The encoder module 114 may receive source video including multiple image frames and then divide the image frames according to a coding structure. Each of the image frames may be divided into at least one image block.

The at least one image block may include a luminance block having multiple luminance samples and at least one chrominance block having multiple chrominance samples. The luminance block and the at least one chrominance block may be further divided to generate macroblocks, CTUs, CBs, sub-divisions thereof, and/or other equivalent coding units.

The encoder module 114 may perform additional sub-divisions of the source video. It should be noted that the disclosed implementations are generally applicable to video coding regardless of how the source video is partitioned prior to and/or during the encoding.

During the encoding process, the prediction processing unit 7141 may receive a current image block of a specific one of the image frames. The current image block may be the luminance block or one of the chrominance blocks in the specific image frame.

The partition unit 71411 may divide the current image block into multiple block units. The intra prediction unit 71412 may perform intra-predictive coding of a current block unit relative to one or more neighboring blocks in the same frame as the current block unit in order to provide spatial prediction. The inter prediction unit 71413 may perform inter-predictive coding of the current block unit relative to one or more blocks in one or more reference image blocks to provide temporal prediction.

The prediction processing unit 7141 may select one of the coding results generated by the intra prediction unit 71412 and the inter prediction unit 71413 based on a mode selection method, such as a cost function. The mode selection method may be a rate-distortion optimization (RDO) process.

The prediction processing unit 7141 may determine the selected coding result and provide a predicted block corresponding to the selected coding result to the first summer 7142 for generating a residual block and to the second summer 7145 for reconstructing the encoded block unit. The prediction processing unit 7141 may further provide syntax elements, such as motion vectors, intra-mode indicators, partition information, and/or other syntax information, to the entropy encoding unit 7148.

The intra prediction unit 71412 may intra-predict the current block unit. The intra prediction unit 71412 may determine an intra prediction mode directed toward a reconstructed sample neighboring the current block unit in order to encode the current block unit.

The intra prediction unit 71412 may encode the current block unit using various intra prediction modes. The intra prediction unit 71412 of the prediction processing unit 7141 may select an appropriate intra prediction mode from the selected modes. The intra prediction unit 71412 may encode the current block unit using a cross-component prediction mode to predict one of the two chroma components of the current block unit based on the luma components of the current block unit. The intra prediction unit 71412 may predict a first one of the two chroma components of the current block unit based on the second of the two chroma components of the current block unit.

The inter prediction unit 71413 may inter-predict the current block unit as an alternative to the intra prediction performed by the intra prediction unit 71412. The inter prediction unit 71413 may perform motion estimation to estimate motion of the current block unit for generating a motion vector.

The motion vector may indicate a displacement of the current block unit within the current image block relative to a reference block unit within a reference image block. The inter prediction unit 71413 may receive at least one reference image block stored in the decoded picture buffer 7147 and estimate the motion based on the received reference image blocks to generate the motion vector.

The first summer 7142 may generate the residual block by subtracting the prediction block determined by the prediction processing unit 7141 from the original current block unit. The first summer 7142 may represent the component or components that perform this subtraction.

The transform/quantization unit (143 may apply a transform to the residual block in order to generate a residual transform coefficient and then quantize the residual transform coefficients to further reduce the bit rate. The transform may be one of a DCT, DST, AMT, MDNSST, HyGT, signal-dependent transform, KLT, wavelet transform, integer transform, sub-band transform, and a conceptually similar transform.

The transform may convert the residual information from a pixel value domain to a transform domain, such as a frequency domain. The degree of quantization may be modified by adjusting a quantization parameter.

The transform/quantization unit 7143 may perform a scan of the matrix including the quantized transform coefficients. Alternatively, the entropy encoding unit 7148 may perform the scan.

The entropy encoding unit 7148 may receive multiple syntax elements from the prediction processing unit 7141 and the transform/quantization unit (143, including a quantization parameter, transform data, motion vectors, intra modes, partition information, and/or other syntax information. The entropy encoding unit 7148 may encode the syntax elements into the bitstream.

The entropy encoding unit 7148 may entropy encode the quantized transform coefficients by performing CAVLC, CABAC, SBAC, PIPE coding, or another entropy coding technique to generate an encoded bitstream. The encoded bitstream may be transmitted to another device (e.g., the second electronic device 120, as shown in FIG. 1) or archived for later transmission or retrieval.

The inverse quantization/inverse transform unit 7144 may apply inverse quantization and inverse transformation to reconstruct the residual block in the pixel domain for later use as a reference block. The second summer 7145 may add the reconstructed residual block to the prediction block provided by the prediction processing unit 7141 in order to produce a reconstructed block for storage in the decoded picture buffer 7147.

The filtering unit 7146 may include a deblocking filter, an SAO filter, a bilateral filter, and/or an ALF to remove blocking artifacts from the reconstructed block. Other filters (in loop or post loop) may be used in addition to the deblocking filter, the SAO filter, the bilateral filter, and the ALF. Such filters are not illustrated for brevity and may filter the output of the second summer 7145.

The decoded picture buffer 7147 may be a reference picture memory that stores the reference block to be used by the encoder module 114 to encode video, such as in intra-coding or inter-coding modes. The decoded picture buffer 7147 may include a variety of memory devices, such as DRAM (e.g., including SDRAM), MRAM, RRAM, or other types of memory devices. The decoded picture buffer 7147 may be on-chip with other components of the encoder module 114 or off-chip relative to those components.

As described above, the method/process 300 for decoding/encoding video data may be performed by the first electronic device 110.

The disclosed implementations are to be considered in all respects as illustrative and not restrictive. It should also be understood that the present disclosure is not limited to the specific disclosed implementations, but that many rearrangements, modifications, and substitutions are possible without departing from the scope of the present disclosure.

What is claimed is:

1. An electronic device for decoding video data, the electronic device comprising:
at least one processor; and
at least one non-transitory computer-readable medium coupled to the at least one processor and storing one or more computer-executable instructions that, when executed by the at least one processor, cause the electronic device to:
receive the video data;
determine a block unit from an image frame retrieved from the video data;
determine a plurality of first block prediction candidates based on a plurality of first intra prediction modes, the plurality of first intra prediction modes comprising at least one non-angular intra prediction mode and a neural network-based intra prediction mode;
determine at least one second block prediction candidate based on at least one second intra prediction mode, the at least one second intra prediction mode comprising at least one angular intra prediction mode;
select at least one first block prediction candidate from the plurality of first block prediction candidates based on a plurality of template costs of the plurality of first block prediction candidates;
determine a block prediction for the block unit by weighted blending the at least one first block prediction candidate and the at least one second block prediction candidate; and
reconstruct the block unit based on the block prediction.

2. The electronic device of claim 1, wherein the at least one non-angular intra prediction mode comprises at least one of a direct current (DC) mode, a planar mode, a block vector-based mode, a position-dependent intra prediction (PDP) mode, or a matrix-based intra prediction (MIP) mode.

3. The electronic device of claim 1, wherein selecting the at least one first block prediction candidate from the plurality of first block prediction candidates comprises:
calculating the plurality of template costs for the plurality of block prediction candidates based on at least one of a sum of absolute difference (SAD), a weighted SAD, a sum of absolute transformed difference (SATD), a mean-removed sum of absolute difference (MR-SAD), a mean absolute difference (MAD), a mean square difference (MSD), or a structural similarity index (SSIM).

4. The electronic device of claim 1, wherein determining the at least one second block prediction candidate comprises:
performing a template-based intra prediction derivation (TIMD) process to determine the at least one second intra prediction mode, the at least one second intra prediction mode comprising two angular intra prediction modes.

5. The electronic device of claim 4, wherein selecting the at least one first block prediction candidate comprises:
determine a first template cost and a second template cost for the two angular intra prediction modes, the first template cost being less than or equal to the second template cost;
determine whether a third template cost of one of the plurality of first block prediction candidates, that is determined based on the neural network-based intra prediction mode, is less than 1.5 times the first template cost; and
in a case that the third template cost is less than 1.5 times the first template cost, select the one of the plurality of first block prediction candidates as the at least one first block prediction candidate.

6. The electronic device of claim 1, wherein the block unit comprises a luma block.

7. The electronic device of claim 1, wherein the block unit comprises a chroma block.

8. An electronic device for encoding video data, the electronic device comprising:
at least one processor; and
at least one non-transitory computer-readable medium coupled to the at least one processor and storing one or more computer-executable instructions that, when executed by the at least one processor, cause the electronic device to:
receive the video data;
determine a block unit from an image frame retrieved from the video data;
determine a plurality of first block prediction candidates based on a plurality of first intra prediction modes, the plurality of first intra prediction modes comprising at least one non-angular intra prediction mode and a neural network-based intra prediction mode;
determine at least one second block prediction candidate based on at least one second intra prediction mode, the at least one second intra prediction mode comprising at least one angular intra prediction mode;
select at least one first block prediction candidate from the plurality of first block prediction candidates based on a plurality of template costs of the plurality of first block prediction candidates;
determine a block prediction for the block unit by weighted blending the at least one first block prediction candidate and the at least one second block prediction candidate; and
reconstruct the block unit based on the block prediction.

9. The electronic device of claim 8, wherein the at least one non-angular intra prediction mode comprises at least one of a direct current (DC) mode, a planar mode, a block vector-based mode, a position-dependent intra prediction (PDP) mode, or a matrix-based intra prediction (MIP) mode.

10. The electronic device of claim 8, wherein selecting the at least one first block prediction candidate from the plurality of first block prediction candidates comprises:
calculating the plurality of template costs for the plurality of block prediction candidates based on at least one of a sum of absolute difference (SAD), a weighted SAD, a sum of absolute transformed difference (SATD), a mean-removed sum of absolute difference (MR-SAD), a mean absolute difference (MAD), a mean square difference (MSD), or a structural similarity index (SSIM).

11. The electronic device of claim 8, wherein determining the at least one second block prediction candidate comprises:
performing a template-based intra prediction derivation (TIMD) process to determine the at least one second intra prediction mode, the at least one second intra prediction mode comprising two angular intra prediction modes.

12. The electronic device of claim 11, wherein selecting the at least one first block prediction candidate comprises:
determine a first template cost and a second template cost for the two angular intra prediction modes, the first template cost being less than or equal to the second template cost;
determine whether a third template cost of one of the plurality of first block prediction candidates, that is determined based on the neural network-based intra prediction mode, is less than 1.5 times the first template cost; and
in a case that the third template cost is less than 1.5 times the first template cost, select the one of the plurality of first block prediction candidates as the at least one first block prediction candidate.

13. The electronic device of claim 8, wherein the block unit comprises a luma block.

14. The electronic device of claim 8, wherein the block unit comprises a chroma block.

15. A non-transitory machine-readable medium of an electronic device storing one or more computer-executable instructions for decoding video data, the one or more computer-executable instructions, when executed by at least one processor of the electronic device, causing the electronic device to:
receive the video data;
determine a block unit from an image frame retrieved from the video data;
determine a plurality of first block prediction candidates based on a plurality of first intra prediction modes, the plurality of first intra prediction modes comprising at least one non-angular intra prediction mode and a neural network-based intra prediction mode;
determine at least one second block prediction candidate based on at least one second intra prediction mode, the at least one second intra prediction mode comprising at least one angular intra prediction mode;
select at least one first block prediction candidate from the plurality of first block prediction candidates based on a plurality of template costs of the plurality of first block prediction candidates;
determine a block prediction for the block unit by weighted blending the at least one first block prediction candidate and the at least one second block prediction candidate; and
reconstruct the block unit based on the block prediction.

16. The electronic device of claim 15, wherein the at least one non-angular intra prediction mode comprises at least one of a direct current (DC) mode, a planar mode, a block vector-based mode, a position-dependent intra prediction (PDP) mode, or a matrix-based intra prediction (MIP) mode.

17. The electronic device of claim 15, wherein selecting the at least one first block prediction candidate from the plurality of first block prediction candidates comprises:
calculating the plurality of template costs for the plurality of block prediction candidates based on at least one of a sum of absolute difference (SAD), a weighted SAD, a sum of absolute transformed difference (SATD), a mean-removed sum of absolute difference (MR-SAD), a mean absolute difference (MAD), a mean square difference (MSD), or a structural similarity index (SSIM).

18. The electronic device of claim 15, wherein determining the at least one second block prediction candidate comprises:
performing a template-based intra prediction derivation (TIMD) process to determine the at least one second intra prediction mode, the at least one second intra prediction mode comprising two angular intra prediction modes.

19. The electronic device of claim 18, wherein selecting the at least one first block prediction candidate comprises:
determine a first template cost and a second template cost for the two angular intra prediction modes, the first template cost being less than or equal to the second template cost;
determine whether a third template cost of one of the plurality of first block prediction candidates, that is determined based on the neural network-based intra prediction mode, is less than 1.5 times the first template cost; and
in a case that the third template cost is less than 1.5 times the first template cost, select the one of the plurality of first block prediction candidates as the at least one first block prediction candidate.

20. The electronic device of claim 8, wherein the block unit comprises a luma block or a chroma block.
